(19) United States
(12) Patent Application Publication
(10) Pub. No.: US 2016/0089720 A1
(43) Pub. Date: Mar. 31, 2016

(54) THREE-DIMENSIONAL FORMING APPARATUS AND THREE-DIMENSIONAL FORMING METHOD

(71) Applicant: SEIKO EPSON CORPORATION, Tokyo (JP)

(72) Inventors: Tomoyuki KAMAKURA, Matsumoto-shi (JP); Takeshi MIYASHITA, Suwa-shi (JP)

(21) Appl. No.: 14/860,020

(22) Filed: Sep. 21, 2015

(30) Foreign Application Priority Data
Sep. 25, 2014 (JP) 2014-194907

(51) Int. Cl. B22F 3/105

(52) U.S. Cl. CPC B22F 3/1055; B33Y 10/00

(57) ABSTRACT

A three-dimensional forming apparatus includes: a material supply unit that supplies a stage with a sintering material in which metal powder and a binder are kneaded; a heating unit that supplies the sintering material supplied from the material supply unit with energy capable of sintering the sintering material; and a driving unit that is able to move the material supply unit and the heating unit three-dimensionally relative to the stage, wherein the material supply unit supplies a predetermined amount of the sintering material to a desired position on the stage and the energy is supplied to the supplied sintering material from the heating unit.

### CROSS-REFERENCE TO RELATED APPLICATIONS

This application claims priority to Japanese Patent Application No. 2014-194907 filed on Sep. 25, 2014. The entire disclosures of Japanese Patent Application No. 2014-194907 is hereby incorporated herein by reference.

### BACKGROUND

1. Technical Field

The present invention relates to a three-dimensional forming apparatus and a three-dimensional forming method.

2. Related Art

In the related art, a method described in JP-A-2008-184622 is disclosed as a manufacturing method of simply forming a three-dimensional shape using a metal material. The three-dimensional fabricated object manufacturing method disclosed in JP-A-2008-184622 is used to form a metal paste, which includes metal powder, a solvent, and an adhesion enhancer in a raw material, in material layers of a layered state. Then, metal sintered layers or metal melted layers are formed by radiating a light beam to material layers of the layered state and the sintered layers or the melted layers are stacked by repeating the forming of the material layers and the radiation of the light beam, so that a desired three-dimensional fabricated object can be obtained.

In the three-dimensional fabricated object manufacturing method disclosed in JP-A-2008-184622, however, only some of the material layers supplied in the layered state are sintered or melted through the radiation of the light beam to be formed as a part of the fabricated object and the material layers to which the light beam is not radiated are unnecessary portions to be merely removed. Further, incomplete sintered or melted material layers may occur near predetermined regions to which the light beam is radiated and the incomplete portions may be attached to portions formed through desired sintering or melting, and thus there is a problem that the shape of the fabricated object is unstable.

### SUMMARY

An advantage of some aspects of the invention is to avoid waste of a material and improve use efficiency of an energy line by supplying the amount of material necessary to form a three-dimensional fabricated object to a predetermined position, radiating the sintering or melting energy line to the supplied material, and forming a desired shape.

The invention can be implemented as the following forms or application examples.

### Application Example 1

A three-dimensional forming apparatus according to this application example includes: a material supply unit that supplies a stage with a sintering material in which metal powder and a binder are kneaded; a heating unit that supplies the sintering material supplied from the material supply unit with energy capable of sintering the sintering material; and a driving unit that is able to move the material supply unit and the heating unit three-dimensionally relative to the stage, in which the material supply unit supplies a predetermined amount of the sintering material to a desired position on the stage and the energy is supplied to the supplied sintering material from the heating unit.

According to the three-dimensional forming apparatus of this application example, the amount of sintering material necessary in a region in which the shape of the three-dimensional fabricated object is formed is supplied and the energy is supplied to the supplied sintering material by the heating unit. Therefore, a loss of the material supply and a loss of the supplied energy are reduced.

In this application example, the sintering in “capable of sintering” refers to transpiring of a binder of the supply material due to the supplied energy and metal bonding between the remaining metal powder by the supplied energy by supplying the energy to the supply material. In the present specification, a form of the melting and bonding of the metal powder will be described as sintering performed by supplying the energy and bonding the metal powder.

### Application Example 2

In the three-dimensional forming apparatus according to the application example described above, the driving unit includes a control unit that controls a movement path of the heating unit such that the heating unit tracks a movement path of the material supply unit.

According to this application example, by driving the heating unit so that the heating unit tracks the movement path of the material supply unit and sequentially sintering or melting the sintering material supplied from the material supply unit to form a predetermined shape, it is possible to prevent a heat influence on the sintering material supplied before the radiation of the energy, for example, a change in the nature or deformation of the sintering material, and thus it is possible to form the three-dimensional fabricated object with high quality.

### Application Example 3

In the three-dimensional forming apparatus according to the application example described above, the three-dimensional forming apparatus includes a plurality of the material supply units, and at least two kinds of the sintering materials with different compositions are supplied.

According to this application example, the material supply unit supplying the sintering material for each different composition can be included. Thus, it is possible to sinter or melt the different material in accordance with the material supply of each material supply unit for each composition and the heating unit, and it is possible to easily form the fabricated object formed of the materials with two or more kinds of compositions.

### Application Example 4

In the three-dimensional forming apparatus according to the application example described above, the heating unit is a laser radiation unit.

According to this application example, it is possible to radiate the energy mainly to a target supply material, and thus it is possible to form the three-dimensional fabricated object with high quality. For example, it is possible to easily control the amount of radiated energy (power, a radiation time, or a scanning speed) in accordance with the kind of sintering material, and thus it is possible to obtain the three-dimensional fabricated object with desired quality.

### Application Example 5

A three-dimensional forming method according to this application example includes: forming a single layer by supplying a sintering material in which metal powder and a binder are kneaded in a desired shape and by supplying energy capable of sintering the sintering material to the sintering material supplied in the supplying of the sintering material and sintering the sintering material; and stacking a first single layer formed in the forming of the single layer and forming a second single layer in the forming of the single layer, in which the stacking of the single layer is repeated a predetermined number of times to form a three-dimensional fabricated object, and in which in the forming of the single layer, the sintering of the sintering material starts before end of the supplying of the sintering material, and the supply of the energy is performed tracking the supply of the sintering material so that the sintering material is sintered.

According to the three-dimensional forming method of this application example, the amount of sintering material necessary in a region in which the shape of the three-dimensional fabricated object is formed is supplied and the energy is supplied to the supplied sintering material by the heating unit. Therefore, a loss of the material supply and a loss of the supplied energy are reduced. Further, by driving the heating unit so that the heating unit tracks the movement path of the material supply unit and sequentially sintering or melting the sintering material supplied from the material supply unit to form a predetermined shape, it is possible to prevent a heat influence on the sintering material supplied before the radiation of the energy, for example, a change in the nature or deformation of the sintering material, and thus it is possible to form the three-dimensional fabricated object with high quality.

### Application Example 6

In the three-dimensional forming method according to the application example described above, in the stacking of the single layer, a support portion supporting the single layer in a gravity direction is formed, and the support portion is an unsintered portion to which the energy is not radiated in the sintering of the sintering material.

According to this application example, it is possible to prevent the supplied soft sintering material in the paste form before the sintering or the melting from being deformed due to gravity, that is, deformed due to the so-called weight of the sintering material, and thus it is possible to form the three-dimensional fabricated object with high quality in a desired shape.

### Application Example 7

In the three-dimensional forming method according to the application example described above, the three-dimensional forming method further includes removing the support portion.

According to this application example, the support portion is in the unsintered state and can be easily removed. Accordingly, even when the support portion is formed at any position, it is possible to obtain the three-dimensional fabricated object with an exact shape without damaging the formation of the three-dimensional fabricated object as a finished product.

### Application Example 8

A three-dimensional forming apparatus according to this application example includes: a first arm; and a second arm, in which the first arm includes a material supply nozzle as a material supply unit supplying a stage with a sintering material in which metal powder and a binder are kneaded and the second arm includes a heating device as a heating unit supplying the sintering material supplied from the material supply unit with energy capable of sintering the sintering material, in which the three-dimensional forming apparatus further comprises a driving unit that is able to move the first arm and the second arm three-dimensionally relative to the stage, and in which the material supply unit supplies a predetermined amount of the sintering material to a desired position on the stage and the energy is supplied to the supplied sintering material from the heating unit.

According to this forming apparatus of this application example, the amount of sintering material necessary in a region in which the shape of the three-dimensional fabricated object is formed is supplied from the material supply nozzle of the first arm, and the energy is supplied to the supplied sintering material by the heating unit of the second arm. Therefore, a loss of the material supply and a loss of the supplied energy are reduced.

### Application Example 9

In the three-dimensional forming apparatus according to the application example described above, the first arm and the second arm include a plurality of joints.

According to this application example, since a complicated shape can be formed, it is possible to form the three-dimensional fabricated object with high efficiency.

### Application Example 10

A three-dimensional forming apparatus according to this application example includes: a control unit that includes a driving control unit for a first arm including a material supply nozzle and a second arm including a heating device, a driving control unit for a stage to which a sintering material is supplied, an operation control unit for the material supply nozzle included in the first arm, and an operation control unit for the heating device included in the second arm.

According to the three-dimensional forming apparatus of this application example, the first arm, the second arm, the stage, the material supply nozzle, and the heating device can be controlled, for example, based on the fabrication data of the three-dimensional fabricated object output from a data output apparatus such as a personal computer. Therefore, it is possible to obtain the three-dimensional fabricated object which has high precision as a finished product.

### Application Example 11

In the three-dimensional forming apparatus according to the application example described above, the control unit further includes a controller operating in cooperation with the first arm, the second arm, the stage, the material supply nozzle, and the heating device.

According to this application example, an operation and driving are performed in cooperation with the first arm, the second arm, the stage, the material supply nozzle, and the heating device. Therefore, even when a complicated shape is formed, it is possible to form the three-dimensional fabricated object with high efficiency.

### BRIEF DESCRIPTION OF THE DRAWINGS

The invention will be described with reference to the accompanying drawings, wherein like numbers reference like elements.

FIG. 1 is a schematic diagram illustrating the configuration of a three-dimensional forming apparatus according to a first embodiment.

FIG. 2 is a schematic diagram illustrating the configuration of a three-dimensional forming apparatus according to a second embodiment.

FIG. 3A is a schematic diagram illustrating the configuration of a three-dimensional forming apparatus according to a third embodiment and FIG. 3B is an expanded view illustrating a part A illustrated in FIG. 3A.

FIG. 4A is a schematic sectional view illustrating a gas supply unit included in the three-dimensional forming apparatus according to the third embodiment and FIGS. 4B and 4C are sectional views illustrating a portion taken along the line B-B′ illustrated in FIG. 4A.

FIGS. 5A and 5B are flowcharts illustrating a three-dimensional forming method according to a fourth embodiment.

FIGS. 6A to 6E are sectional views illustrating processes of the three-dimensional forming method according to the fourth embodiment.

FIGS. 7A to 7D are sectional views illustrating processes of the three-dimensional forming method according to the fourth embodiment.

FIG. 8A is an external plan view illustrating the outer appearance of a three-dimensional fabricated object according to a fifth embodiment and FIG. 8B is an external side view illustrating the outer appearance of the three-dimensional fabricated object.

FIG. 9 is a flowchart illustrating a three-dimensional forming method according to the fifth embodiment.

FIGS. 10A to 10D are sectional views illustrating processes of the three-dimensional forming method according to the fifth embodiment.

FIGS. 11A and 11B are external plan views illustrating the outer appearance of another example of a three-dimensional fabricated object according to the three-dimensional forming method according to the fifth embodiment and FIG. 11C is a sectional view illustrating the three-dimensional fabricated object.

### DESCRIPTION OF EXEMPLARY EMBODIMENTS

Hereinafter, embodiments of the invention will be described with reference to the drawings.

### First Embodiment

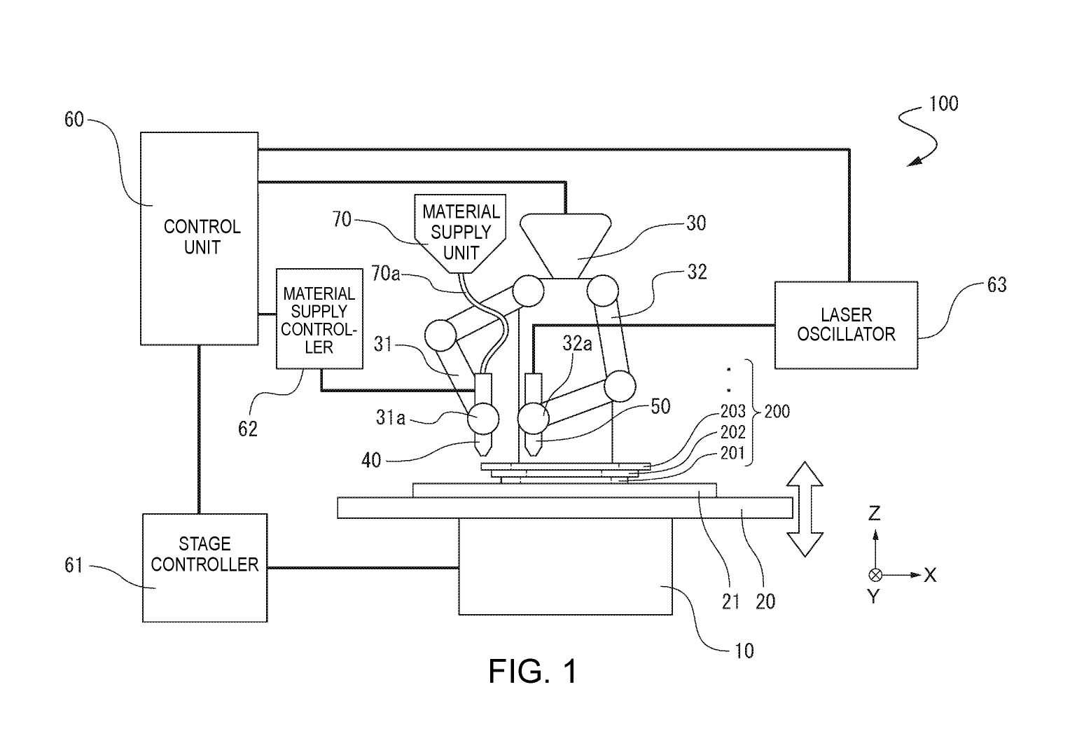

FIG. 1 is a schematic diagram illustrating the configuration of a three-dimensional forming apparatus according to a first embodiment. In the present specification, “three-dimensional forming” refers to forming a so-called stereoscopically fabricated object and includes, for example, forming a shape having a thickness even when the shape is a flat shape or a so-called two-dimensional shape.

As illustrated in FIG. 1, a three-dimensional forming apparatus 100 includes a base 10, a stage 20 included to be able to be driven in the Z direction illustrated in the drawing by a driving unit (not illustrated) included in the base 10, and a robot 30 serving as a driving unit that holds a material supply unit and a heating unit to be described below and is able to move the material supply unit and the heating unit. On the stage 20, partial fabricated objects 201, 202, and 203 are formed in layer states while being formed in a three-dimensional fabricated object 200. As will be described in the formation of the three-dimensional fabricated object 200, heat energy is radiated through a laser. Therefore, to protect the stage 20 from heat, a sample plate 21 with a heat resistance property may be used so that the three-dimensional fabricated object 200 is formed on the sample plate 21. For example, by using a ceramic plate as the sample plate 21, a high heat resistance property can be obtained, reactivity to a supplied material to be sintered or melted is also low, and a change in the nature of the three-dimensional fabricated object 200 can be prevented. In FIG. 1, three layers, the partial fabricated objects 201, 202, and 203, are exemplified to facilitate the description. However, the partial fabricated objects are stacked up in the shape of the desired three-dimensional fabricated object 200.

As illustrated in the drawing, the robot 30 is a so-called double-arm robot that includes a first arm 31 and a second arm 32. A material supply nozzle 40 (hereinafter referred to as the nozzle 40) serving as a material supply unit that supplies a sintering material which is a material of the three-dimensional fabricated object 200 is gripped or fixed to a first hand unit 31a of the first arm 31. A laser radiation device 50 serving as a heating unit is gripped or fixed to a second hand unit 32a of the second arm 32.

In the robot 30, the arms 31 and 32 include a plurality of joints (flexibility), and thus the hand units 31a and 32a can be driven three-dimensionally, that is, can be driven in the X axis direction, the Y axis direction, and the Z axis direction illustrated the drawing. In addition to operations of the arms 31 and 32, the nozzle 40 gripped or fixed to the first hand unit 31a and the laser radiation device 50 gripped or fixed to the second hand unit 32a can be moved three-dimensionally relative to the stage 20 through movement of the stage 20 included in the base 10 in the Z direction. The hand units 31a and 32a included in the arms 31 and 32 are connected to be rotatable with respect to the joints, and thus can be rotated, for example, using axes extending along the X axis, the Y axis, and the Z axis as rotation axes. In the three-dimensional forming apparatus 100, the Z axis direction is a direction along the gravity direction.

The three-dimensional forming apparatus 100 includes a control unit 60 serving as a control unit that controls the stage 20, the robot 30, the nozzle 40, and the laser radiation device 50 described above based on fabrication data of the three-dimensional fabricated object 200 output from, for example, a data output apparatus such as a personal computer (not illustrated). Although not illustrated in the drawing, the control unit 60 at least includes a driving control unit for the first arm 31 and the second arm 32 of the robot 30, a driving control unit of the stage 20, an operation control unit of the nozzle 40, and an operation control unit of the laser radiation device 50. The control unit 60 further includes a control unit driven and operated in cooperation with the robot 30, the stage 20, the nozzle 40, and the laser radiation device 50.

In regard to the stage 20 included to be able to be moved to the base 10, signals used to control movement start and stop, a movement direction, a movement amount, a movement speed, and the like of the stage 20 are generated based on control signals from the control unit 60 in a stage controller 61 and are transmitted to a driving device (not illustrated) included in the base 10 for driving.

In regard to the nozzle 40 gripped or fixed to the first hand unit 31a of the first arm 31, a signal used to control the amount of material to be supplied or the like from the nozzle 40 is generated based on a control signal from the control unit 60 in a material supply controller 62, and thus an appropriate amount of material is supplied from the nozzle 40.

A supply tube 70a serving as a material supply path is extended from the material supply unit 70 and is connected to the nozzle 40. The material supply unit 70 accommodates, as a supply material, a sintering material including a raw material of the three-dimensional fabricated object 200 fabricated by the three-dimensional forming apparatus 100 according to the embodiment. The sintering material which is the supply material is a mixed material of a slurry state (or a paste form) obtained by kneading, for example, an elementary powder of metals such as magnesium (Mg), iron (Fe), cobalt (Co), chrome (Cr), AL (aluminum), titanium (Ti), and nickel (Ni) which are raw materials of the three-dimensional fabricated object 200, or a mixed powder of an alloy including one or more of the metals with a solvent and a thickener serving as a binder. The average grain diameter of the metal powder is preferably equal to or less than 10 μm, the solvent is preferably a water soluble solvent, and the thickener with a hydroxyl group such as PVA (polyvinyl alcohol) or CeNF (nano-cellulose) is preferably used. For example, a thermoplastic resin such as PLA (polylactic acid), PA (polyamide), or PPS (polyphenylene sulfide) can also be used. When the thermoplastic resin is used, the nozzle 40 and the material supply unit 70 are heated so that softness of the thermoplastic resin is maintained. A supply property can be improved by using a silicone oil or the like as the solvent.

In regard to the laser radiation device 50 gripped or fixed to the second hand unit 32a of the second arm 32, a predetermined output laser is oscillated by the laser oscillator 63 based on a control signal from the control unit and a laser is radiated from a radiation unit (not illustrated) of the laser radiation device 50. The laser is radiated to the supply material ejected from the nozzle 40, and thus the metal powder included in the supply material is sintered or melted to be solidified. At this time, the solvent and the thickener included in the supply material simultaneously transpire by the heat of the laser. The laser used for the three-dimensional forming apparatus 100 according to the embodiment is not particularly limited. A fiber laser or a carbon dioxide laser is appropriately used since a wavelength is long and metal absorption efficiency is high. A fiber laser is more preferable since an output is high and a fabrication time can be shortened.

The supply material from the nozzle 40 is supplied along the movement path of the nozzle 40 based on fabrication data of the three-dimensional fabricated object 200 acquired from the control unit 60. For the laser radiation device 50, similarly, a movement path is formed along the movement path of the nozzle 40, that is, a supply region of the supply material, based on the fabrication data of the three-dimensional fabricated object 200 acquired from the control unit 60. The radiation of the laser from the laser radiation device 50 is preferably performed to track the supply of the material from the nozzle 40.

The tracking refers to the start of radiation of the laser from the laser radiation device 50 before the supply of the supply material from the nozzle 40 is completed at least along the shape of the partial fabricated object 201, for example, when the partial fabricated object 201 is formed. Preferably, the nozzle 40 and the laser radiation device 50 are moved for proximity tracking. A distance between the nozzle 40 and the laser radiation device 50 is appropriately set in a range in which a heat influence is not given to the supply material immediately after the supply material is ejected from a material supply port of the nozzle 40, and the distance is preferably maintained during the movement path of the nozzle 40.

In the three-dimensional forming apparatus 100 according to the first embodiment, the three-dimensional fabricated object 200 is formed in such a manner that the supply material is supplied from the nozzle 40 along the fabrication shape of the three-dimensional fabricated object 200 and is sintered or melted sequentially through the radiation of the laser from the laser radiation device 50 moved to track the nozzle 40. In the forming of the partial fabricated object 201 as an example of the forming of the partial fabricated objects 201, 202, and 203 formed in the layered state, a case is assumed in which operations of first supplying the sintering material (a material before sintering) in the shape of the partial fabricated object 201, and then radiating the laser from the laser radiation device 50 and sintering the material are performed. In the operations, there is a concern of the three-dimensional fabricated object 200 with desired quality and shape being rarely obtained due to the heat influence of the energy of the laser on an unsintered portion in a region distant from the laser radiation device 50 and a change in the nature or deformation of the supply material before sintering.

In the three-dimensional forming apparatus 100 according to the embodiment, the partial fabricated object 201 is formed in such a manner that the supply material is supplied from the nozzle 40 along the fabrication shape of the layered state of the partial fabricated object 201 of the three-dimensional fabricated object 200 and is sintered or melted sequentially through the radiation of the laser from the laser radiation device 50 moved to track the nozzle 40. Thus, it is possible to reliably form the three-dimensional fabricated object 200 including the desired partial fabricated objects in the layered state. Further, in the three-dimensional forming apparatus 100, since the material is supplied only to the regions of the shapes of the partial fabricated objects, the three-dimensional forming can be performed with a small loss of the material.

In the three-dimensional forming apparatus 100 according to the embodiment, the double-arm robot 30 has been exemplified as the movement driving unit of the nozzle 40 and the laser radiation device 50, but the invention is not limited thereto. For example, each of the nozzle 40 and the laser radiation device 50 may be driven by an articulated robot or an orthogonal robot.

### Second Embodiment

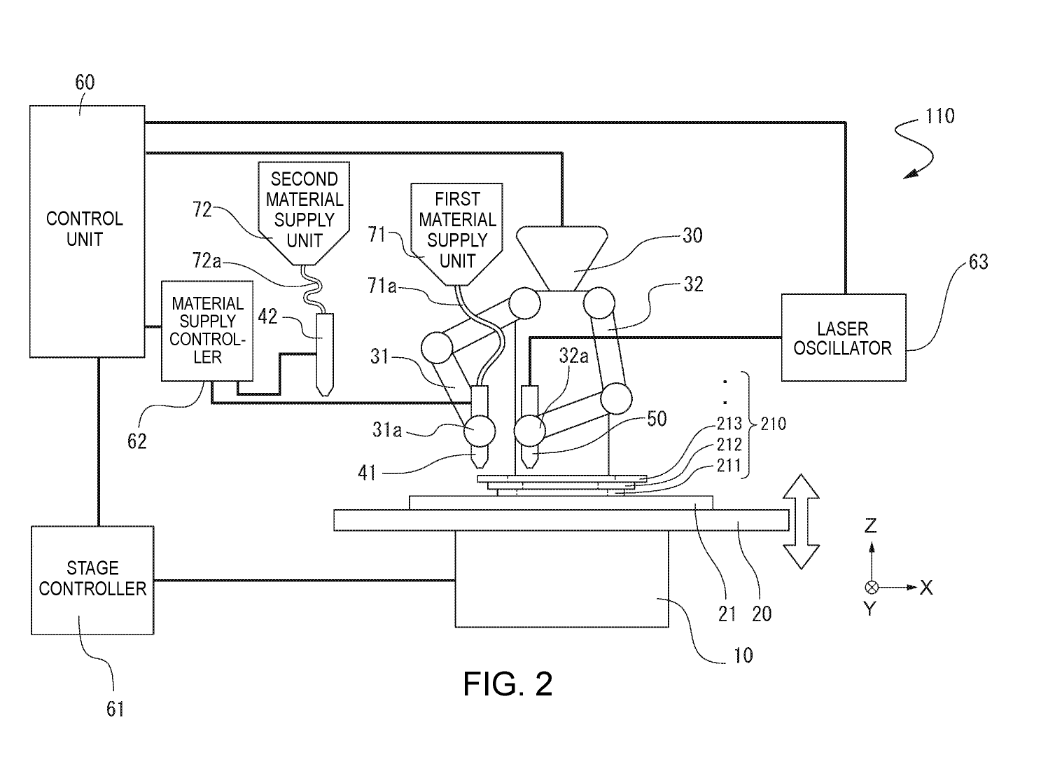

FIG. 2 is a schematic diagram illustrating the configuration of a three-dimensional forming apparatus according to a second embodiment. In a three-dimensional forming apparatus 110 illustrated in FIG. 2, a plurality of kinds of supply materials, two kinds of supply materials in the embodiment, are used compared to the three-dimensional forming apparatus 100 according to the first embodiment. The same reference numerals are given to the same constituent elements as those of the three-dimensional forming apparatus 100 according to the first embodiment, and the description thereof will be omitted.

As illustrated in FIG. 2, the three-dimensional forming apparatus 110 includes a first material supply unit 71 and a second material supply unit 72. A first supply tube 71a serving as a material supply path is extended to the first material supply unit 71 and a first nozzle 41 is connected to the end of the first supply tube 71a. Similarly, a second supply tube 72a serving as a material supply path is extended to the second material supply unit 72 and a second nozzle 42 is connected to the end of the second supply tube 72a.

The first material supply unit 71 and the second material supply unit 72 accommodate different supply materials. Based on an instruction from the control unit 60 in regard to a material to be supplied, the first hand unit 31a included in the first arm 31 selects and grips a desired nozzle between the first nozzle 41 and the second nozzle 42, so that the supply material is supplied.

In the three-dimensional forming apparatus 110 according to the embodiment, a partial fabricated object 211, a partial fabricated object 212, or a partial fabricated object 213 can be formed in such a manner that the supply material which is a sintering material supplied from one of the first material supply unit 71 and the second material supply unit 72 is sintered or melted to form a partial fabricated object, and then the supply material is supplied from the other material supply unit and is sintered or melted to form the partial fabricated object.

In this example, the two material supply units 71 and 72 have been exemplified, but the invention is not limited thereto. Three or more material supply units can be included, and thus a three-dimensional fabricated object 210 can be formed using three or more kinds of different supply materials. The material supply units 71 and 72 may accommodate the same supply material. That is, when there is a large amount of supply material or one of the material supply units is broken down, the material supply unit can be used as a preliminary material supply unit.

### Third Embodiment

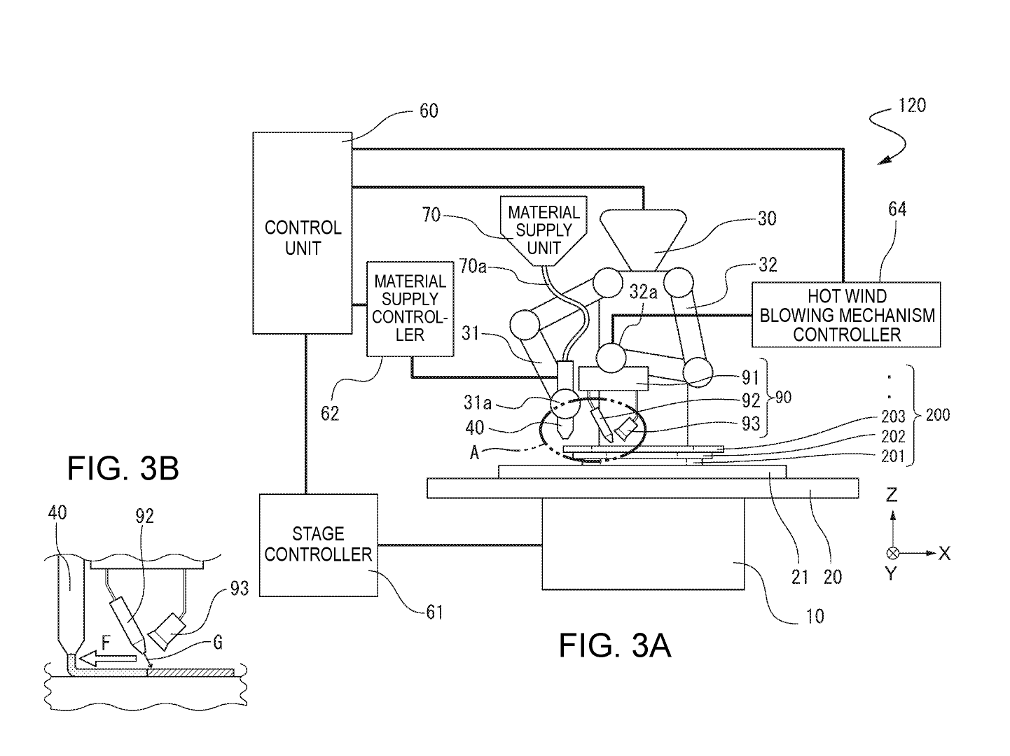

FIGS. 3A and 3B are diagrams illustrating the configuration of a three-dimensional forming apparatus 120 according to a third embodiment. The three-dimensional forming apparatus 120 illustrated in FIG. 3A according to the embodiment has a different configuration of the heating unit from the three-dimensional forming apparatus 100 according to the first embodiment. The same reference numerals are given to the same constituent elements as those of the three-dimensional forming apparatus 100 according to the first embodiment, and the description thereof will be omitted.

As illustrated in FIG. 3A, the three-dimensional forming apparatus 120 includes a hot wind blowing mechanism 90 as a heating unit. The hot wind blowing mechanism 90 includes a compressor 91, a gas supply unit 92, and a duct 93. The hot wind blowing mechanism 90 is controlled by a hot wind blowing mechanism controller 64 connected to the control unit 60.

The compressor 91 includes a compression unit compressing a gas (not illustrated) at high pressure and supplies the gas compressed at the high pressure by the compression unit to the gas supply unit 92. An inert gas capable of preventing generation of a change in the nature of the material at the time of heating of the supply material is preferably used as the gas. The duct 93 is disposed in close proximity to the gas supply unit 92. The duct 93 is connected to the compressor 91, absorbs a supply gas G ejected to the supply material from the gas supply unit 92 and a transpired gas of the solvent and the thickener included in the supply material transpired by the heated supply gas G, and exhausts the supply gas G and the transpired gas to the outside via the compressor 91 or sends the supply gas G and the transpired gas to an inert gas recovery unit (not illustrated).

As illustrated in FIG. 3B which is a partial expanded view of a portion A illustrated in FIG. 3A, the hot wind blowing mechanism 90 includes the gas supply unit 92 so that a supply direction of the gas G supplied from the gas supply unit 92 is directed to the downstream side in a material supply direction F when a direction indicated by an illustrated arrow in which the supply material is moved while being supplied from the nozzle 40 is the material supply direction F. Thus, it is possible to prevent the supply material from being heated at a position other than a position at which predetermined sintering or melting is performed, and it is possible to avoid wrong fabrication.

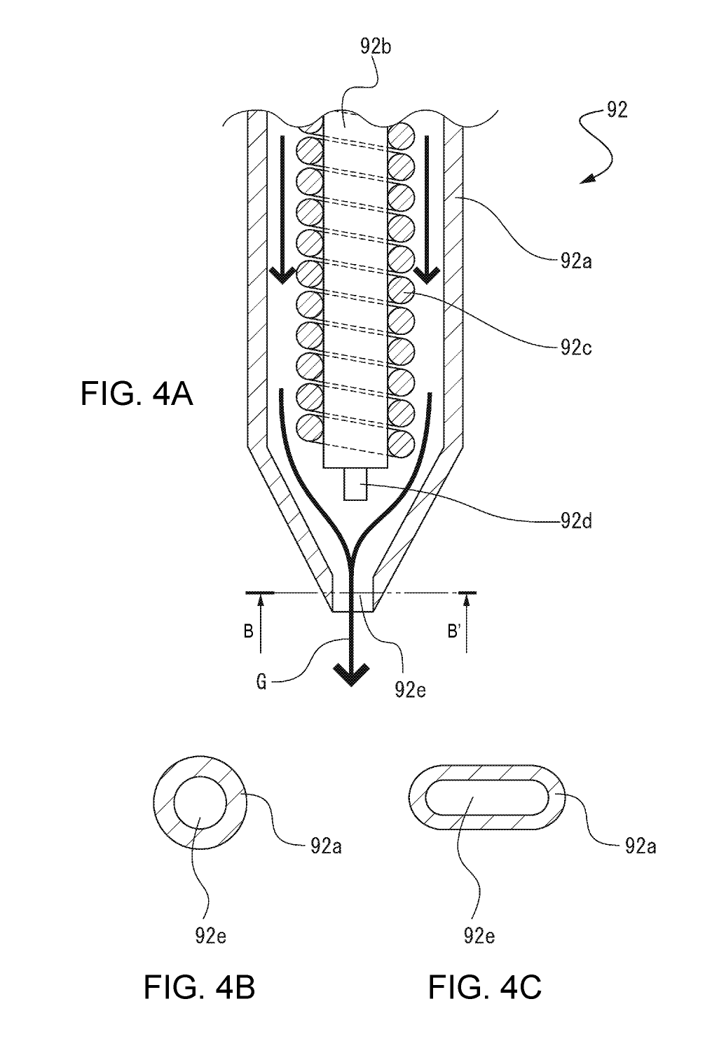

FIG. 4A is a schematic sectional view illustrating the gas supply unit 92. As illustrated in FIG. 4A, the gas supply unit 92 includes at least a heat-resistant syringe 92a, a core 92b, a heater coil 92c wound around the core 92b, and a temperature sensor 92d. For example, the heat-resistant syringe 92a is formed in a cylindrical shape such as a circular cylindrical shape using heat-resistant glass or heat-resistant metal. A high-pressure gas is introduced inside the heat-resistant syringe 92a from the compressor 91.

The core 92b is arranged along the central axis of the heat-resistant syringe 92a and the heater coil 92c generating heat when a current flows in the core 92b from an external power source (not illustrated) is wound around the core 92b. The high-pressure gas introduced inside the heat-resistant syringe 92a is heated by the heater coil 92c generating the heat and is ejected as a hot wind from an ejection port 92e formed at the proximal end of the heat-resistant syringe 92a.

The temperature of the ejected hot wind is detected by the temperature sensor 92d disposed on the side of the ejection port 92e of the core 92b and the strength of the current flowing in the heater coil 92c is controlled, so that the hot wind with a desired temperature can be generated. The ejection port 92e preferably has a shape illustrated in FIG. 4B or 4C illustrating a cross-sectional surface of a portion taken along the line B-B′ illustrated in FIG. 4A so that the generated hot wind is blown and concentrated on the supply material. FIG. 4B illustrates a circular opening by which the hot wind can be further concentrated and FIG. 4C illustrates a track-shaped opening by which the hot wind can be blown more widely.

### Fourth Embodiment

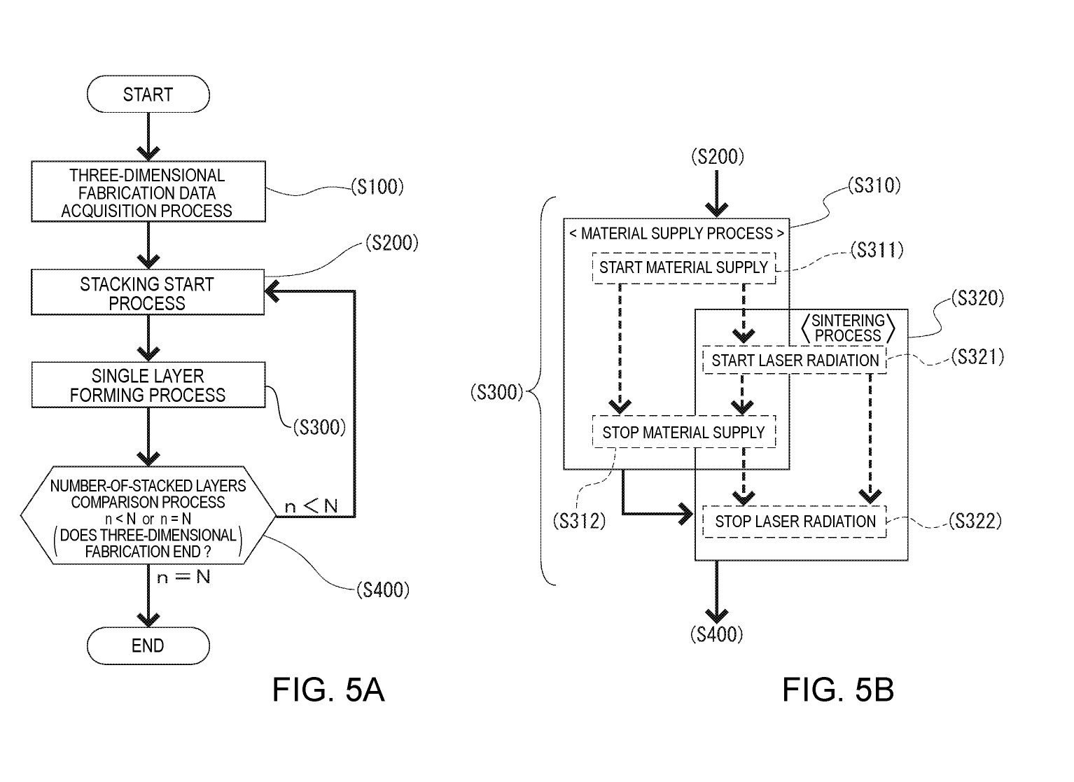

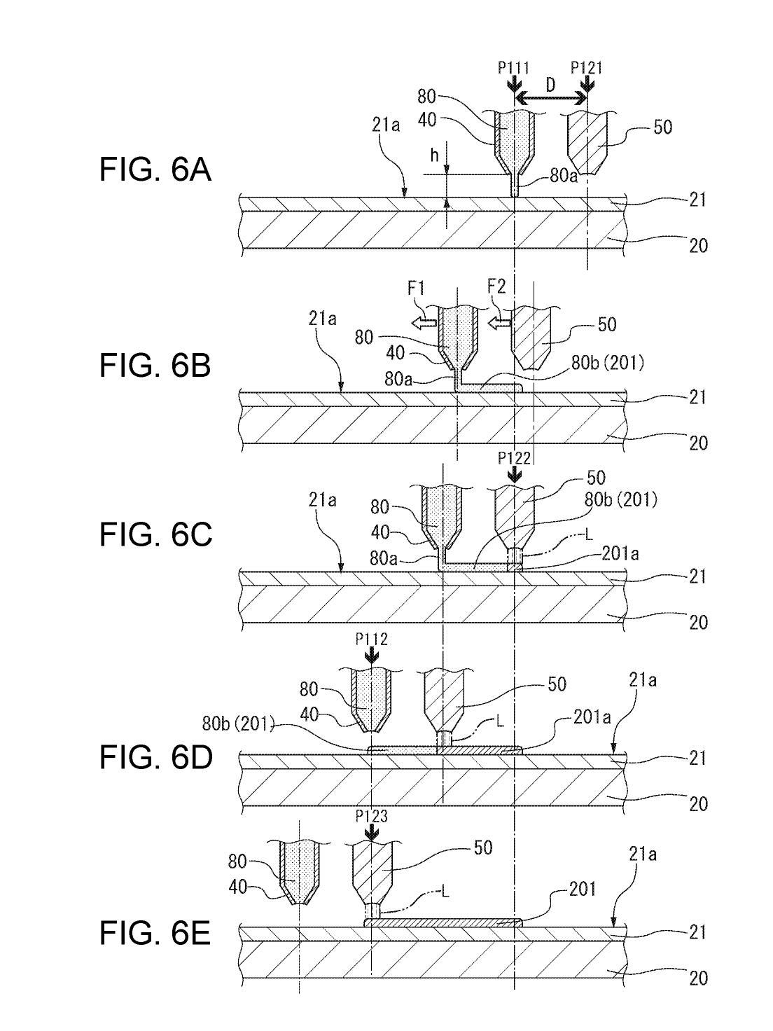

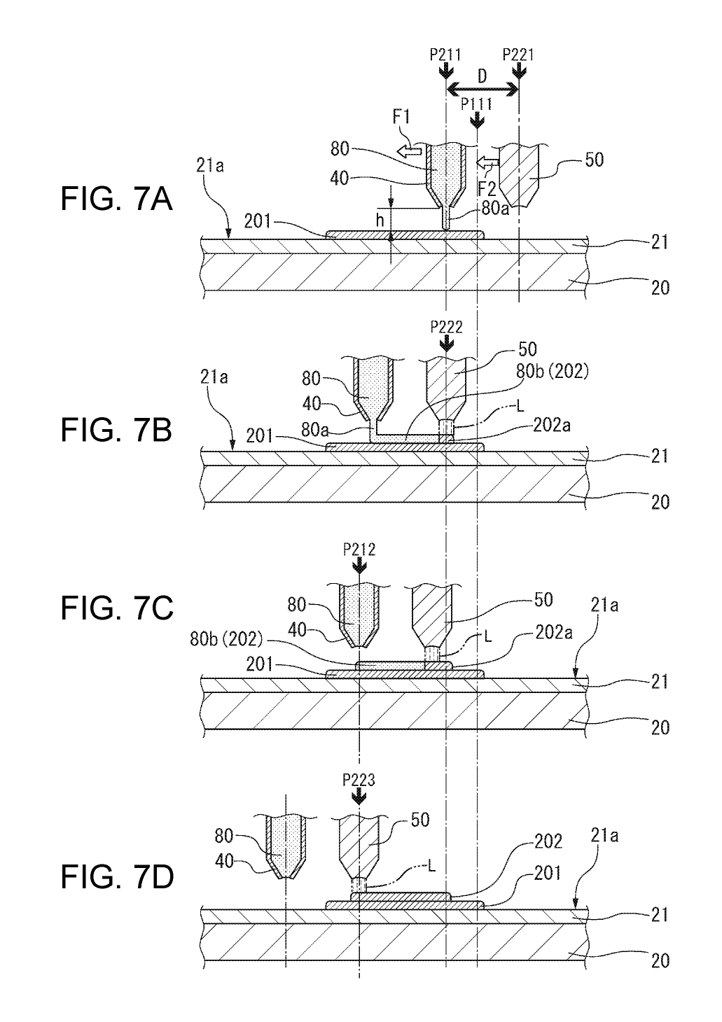

A three-dimensional forming method of forming a three-dimensional fabricated object using the three-dimensional forming apparatus 100 according to the first embodiment will be described as a fourth embodiment. FIG. 5A is a flowchart illustrating the three-dimensional forming method according to the fourth embodiment and FIG. 5B is a detailed flowchart illustrating a single layer forming process (S200) illustrated in FIG. 5A. FIGS. 6A to 6E and FIGS. 7A to 7D are partial sectional views illustrating processes of the three-dimensional forming method according to the embodiment.

### Three-Dimensional Fabrication Data Acquisition Process

As illustrated in FIG. 5A, in the three-dimensional forming method according to the embodiment, a three-dimensional fabrication acquisition process (S100) of acquiring three-dimensional fabrication data of the three-dimensional fabricated object 200 from, for example, a personal computer (not illustrated) by the control unit 60 (see FIG. 1) is performed. In regard to the three-dimensional fabrication data acquired in the three-dimensional fabrication acquisition process (S100), the control data is transmitted from the control unit 60 to the robot 30, the stage controller 61, the material supply controller 62, and the laser oscillator 63, and then the process proceeds to a stacking start process.

### Stacking Start Process

In the stacking start process (S200), as illustrated in FIG. 6A illustrating the three-dimensional forming method, the nozzle 40 is moved to a fabrication start point P111 of the partial fabricated object 201 (see FIG. 1), which becomes a first layer which is a first single layer of the three-dimensional fabricated object, at a predetermined interval h from the sample plate 21 placed on the stage 20. At this time, the laser radiation device 50 is disposed at a rear position P121 in a movement direction of the nozzle 40 to be described below and a separation distance D is maintained. When the nozzle 40 and the laser radiation device 50 are disposed at predetermined positions, the process proceeds to a single layer forming process.

### Single Layer Forming Process

The single layer forming process (S300) includes a material supply process (S310) and a sintering process (S320), as illustrated in FIG. 5B. First, the material supply starts (S311) by supplying the supply material 80 which is the sintering material from the nozzle 40 disposed at the predetermined position as an extruded portion 80a on the sample plate 21 in the stacking start process (S200). The supply material 80 is a material in which an elementary powder of a metal which is the raw material of the three-dimensional fabricated object 200, for example, an alloy of stainless steel and titanium, or a mixed powder of stainless steel and copper (Cu) which are difficult to alloy, an alloy of stainless and titanium, or a titanium alloy and cobalt (Co) or chrome (Cr) is kneaded with a solvent and a thickener serving as a binder, and is adjusted in a slurry state (or a paste form).

Next, as illustrated in FIG. 6B, a fabrication material 80b before sintering or melting of which the partial fabricated object 201 is formed is disposed by relatively moving the nozzle 40 and the stage 20 on which the sample plate 21 is loaded in the illustrated arrow direction F1 while supplying the supply material 80 to an upper surface 21a of the sample plate 21 so that the shape of the partial fabricated object 201 is formed. Further, the laser radiation device 50 is moved in an illustrated arrow direction F2 while the separation distance D is maintained with the movement of the nozzle 40 in the arrow direction F1.

The supply material 80 is supplied as the fabrication material 80b from the nozzle 40 to the upper surface 21a of the sample plate 21 in accordance with the partial fabricated object 201. As illustrated in FIG. 6C, when the laser radiation device 50 is moved to a position P122 overlapping the supply start position P111 of the fabrication material 80b, the laser radiation starts (S321) to start the radiation of a laser L as supply energy to the fabrication material 80b. For the fabrication material 80b in the region to which the laser L is radiated, the solvent and the thickener are transpired due to the energy (heat) of the laser L and the metal powder particles are bonded, that is, subjected to so-called sintering or melting and bonding, so that a fabrication progress region 201a of the partial fabricated object 201 is formed.

As illustrated in FIG. 6D, the supply material 80 is supplied from the nozzle 40 to the upper surface 21a of the sample plate 21 and the fabrication material 80b is sequentially formed, and the fabrication progress region 201a is sequentially formed by radiating the laser L to the fabrication material 80b while maintaining the separation distance D and moving the laser radiation device 50 so that the laser radiation device 50 tracks the nozzle 40. Then, the nozzle 40 reaches a position P112 which is a shape region end point of the partial fabricated object 201 and the supply of the supply material 80 is stopped, so that the material supply stops (S312).

Even after the material supply stops (S312), the laser radiation device 50 tracks the movement path of the nozzle 40 to form the fabrication progress region 201a while the laser radiation device 50 radiates the laser L. As illustrated in FIG. 6E, the laser radiation device 50 reaches the position P112 at which the forming of the fabrication material 80b ends and the radiation of the laser L is cut at a position P123, so that the laser radiation stops (S322). In this way, the partial fabricated object 201 which is the first single layer is formed on the upper surface 21a of the sample plate 21.

As described above, in the single layer forming process (S300), the material supply process (S310) from the material supply start process (S311) to the material supply stop process (S312) progresses and the sintering process (S320) from the laser radiation start process (S321) to the laser radiation stop process (S322) progresses. In the sintering process (S320), the laser radiation start process (S321) is set to be performed after the material supply start (S311) and before the material supply stop process (S312).

As described above, in the three-dimensional forming method according to the embodiment using the three-dimensional apparatus 100, the laser L is radiated to the supplied fabrication material 80b by moving the laser radiation device 50 to track the nozzle 40 while maintaining the predetermined separation distance D with respect to the nozzle 40 supplying the supply material 80 to the upper surface 21a of the sample plate 21, and thus the fabrication material 80b is sequentially sintered or melted to be formed as the partial fabricated object 201. By forming the fabricated object in this way, it is possible to shorten an amount of time elapsed from the forming of the fabrication material 80b to the radiation of the laser L, and thus it is possible to reduce the heat influence of the laser L on the fabrication material 80b formed outside the radiation region of the laser L. Accordingly, it is possible to prevent a decrease in the viscosity of the thickener included in the fabrication material 80b which is being formed, and thus it is possible to suppress deformation of the formed fabrication material 80b.

In the above-described single layer forming process (S300), the description has been made using the three-dimensional forming apparatus 100 according to the first embodiment. However, the sample can apply even when the three-dimensional forming apparatus 110 according to the second embodiment is used or the three-dimensional forming apparatus 120 according to the third embodiment is used.

When the three-dimensional forming apparatus 110 according to the second embodiment is used, the processes from the material supply process (S310) to the sintering process (S320) are performed for each of the different materials prepared in the first material supply unit 71 and the second material supply unit 72, and thus a partial fabricated object of a composite material is formed. When the three-dimensional forming apparatus 120 according to the third embodiment is used, the energy (heat) supplied in the sintering process (S320) is a hot wind ejected from the gas supply unit 92 and the supply material is sintered or melted by the hot wind so that the partial fabricated object is formed.

### Stack Number Comparison Process

When the partial fabricated object 201 which is the first layer is formed through the single layer forming process (S300), the process proceeds to a stack number comparison process (S400) of performing comparison with the fabrication data obtained through the three-dimensional fabrication data acquisition process (S100). In the stack number comparison process (S400), the number of stacked layers N of the partial fabricated objects included in the three-dimensional fabricated object 200 is compared to the number of stacked layers n of the partial fabricated objects stacked up to the single layer forming process (S300) immediately before the stack number comparison process (S400).

When n=N is determined in the stack number comparison process (S400), it is determined that the forming of the three-dimensional fabricated object 200 is completed and the three-dimensional forming ends. Conversely, when n<N is determined, the process is performed again from the stacking start process (S200).

FIGS. 7A to 7D are partial sectional views illustrating a method of forming the partial fabricated object 202 of a second layer which is a second single layer. As illustrated in FIG. 7A, the stacking start process (S200) is first performed again. At this time, the stage 20 or the first arm 31 and the second arm 32 are driven so that the stage 20, and the nozzle 40 and the laser radiation device 50 are separated relatively by the thickness of the partial fabricated object 201 of the first layer. Then, the nozzle 40 is moved to a fabrication start point P211 of the partial fabricated object 202 (see FIG. 1) to be fabricated on the partial fabricated object 201 at the predetermined interval h between the partial fabricated object 201 and the nozzle 40. At this time, as described above, the laser radiation device 50 is disposed at a rear position P221 in the arrow direction F1 of the movement of the nozzle 40 and the separation distance D is maintained. When the nozzle 40 and the laser radiation device 50 are disposed at predetermined positions, the single layer forming process (S300) is performed.

Thereafter, as in FIGS. 6A to 6E illustrating the forming of the partial fabricated object 201 described above, the single layer forming process (S300) is performed. As illustrated in FIG. 7A, first, at the position P211 at which the partial fabricated object 202 (see FIG. 1) starts on the partial fabricated object 201, the material supply starts (S311) by supplying the supply material 80 from the nozzle 40 as the extruded portion 80a to the partial fabricated object 201. Then, the fabrication material 80b before sintering or melting of which the partial fabricated object 202 is formed is disposed by relatively moving the nozzle 40 and the stage 20 on which the sample plate 21 is loaded in the illustrated arrow direction F1 while supplying the supply material 80 onto the partial fabricated object 201 so that the shape of the partial fabricated object 202 is formed. Further, the laser radiation device 50 is moved in the illustrated arrow direction F2 while the separation distance D is maintained with the movement of the nozzle 40 in the arrow direction F1.

The supply material 80 is supplied as the fabrication material 80b from the nozzle 40 to partial fabricated object 201 in accordance with the partial fabricated object 202. As illustrated in FIG. 7B, when the laser radiation device 50 is moved to a position P222 overlapping the supply start position P211 of the fabrication material 80b, the laser radiation starts (S321) to start the radiation of a laser L as supply energy to the fabrication material 80b. For the fabrication material 80b in the region to which the laser L is radiated, the solvent and the thickener are transpired due to the energy (heat) of the laser L and the metal powder particles are bonded, that is, subjected to so-called sintering or melting, so that a fabrication progress region 202a of the partial fabricated object 202 is formed. At this time, the fabrication progress region 202a is sintered or melted with the partial fabricated object 201 of the lower layer to be bonded.

As illustrated in FIG. 7C, the supply material 80 is supplied from the nozzle 40 onto the partial fabricated object 201 and the fabrication material 80b is sequentially formed, and the fabrication progress region 202a is sequentially formed by radiating the laser L to the fabrication material 80b while maintaining the separation distance D and moving the laser radiation device 50 so that the laser radiation device 50 tracks the nozzle 40. Then, in the region in which the partial fabricated object 202 is formed, the nozzle 40 reaches a position P212 at which the forming of the fabrication material 80b ends, and the supply of the supply material 80 is stopped, so that the material supply stops (S312).

As illustrated in FIG. 7D, the laser radiation device 50 reaches the position P212 at which the forming of the fabrication material 80b ends and the radiation of the laser L is cut at a position P223, so that the laser radiation stops (S322). In this way, the partial fabricated object 202 is formed on the partial fabricated object 201, and thus is formed as a part of the three-dimensional fabricated object. Then, the process proceeds to the stack number comparison process (S400) again. The stacking start process (S200) and the single layer forming process (S300) are repeated until n=N, and thus the three-dimensional fabricated object can be formed using the three-dimensional forming apparatus 100 according to the first embodiment.

A process of performing the stacking start process (S200) of forming the partial fabricated object 202 of the second layer which is the second single layer on the partial fabricated object 201 of the first layer which is the first single layer and the single layer forming process (S300) is referred to as a stacking process in the above-described application example. In the stack number comparison process (S400), the stacking process is repeated until n=N.

### Fifth Embodiment

A three-dimensional forming method according to the fifth embodiment will be described. In the three-dimensional forming method according to the above-described fourth embodiment, when the three-dimensional fabricated object has an overhang, there is a concern of an overhang of the fabrication material 80b before sintering being deviated from a formed region of the partial fabricated object of the lower layer and being deformed in the gravity direction due to gravity in the above-described single layer forming process (S300). That is, before the sintering, the fabrication material 80b is a material in a slurry state (or a paste form) obtained by kneading an elementary powder of a metal which is the raw material of the three-dimensional fabricated object 200, for example, an alloy of stainless steel and titanium, or a mixed powder of stainless steel and copper (Cu) which are difficult to alloy, an alloy of stainless steel and titanium, or a titanium alloy and cobalt (Co) or chrome (Cr) with a solvent and a thickener. Further, the laser L which is a heating element is radiated from the laser radiation device 50 disposed near the nozzle 40, even slightly the fabrication material 80b receives the heat influence, and the deformation in the gravity direction is accelerated.

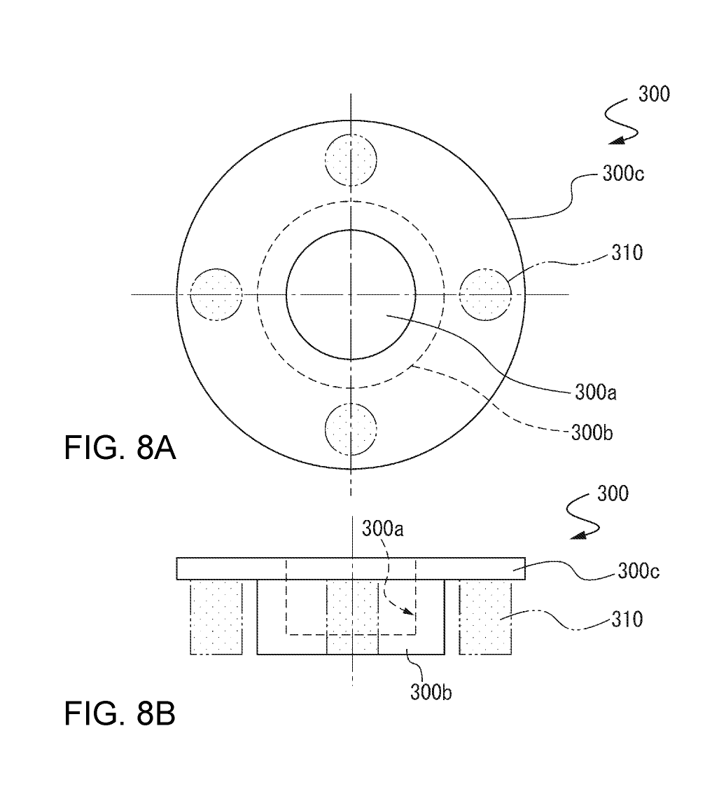

Accordingly, a method of forming a three-dimensional fabricated object without deforming an overhang according to the three-dimensional forming method according to the fifth embodiment will be described. The same reference numerals are given to the same processes as those of the three-dimensional forming method according to the fourth embodiment, and the description thereof will be omitted. To facilitate the description, as illustrated in the external plan view of FIG. 8A and the external side view of FIG. 8B, a three-dimensional fabricated object 300 with a simple shape will be exemplified to describe the three-dimensional forming method according to the fifth embodiment, but the invention is not limited to this shape. The invention can apply when a fabricated object has a so-called overhang.

As illustrated in FIGS. 8A and 8B, the three-dimensional fabricated object 300 includes a flange portion 300c which is an overhang extending to the outer side of a base portion 300b in an concave opening-side end of the columnar base portion 300b including a concave portion 300a. To form the three-dimensional fabricated object 300 based on the three-dimensional forming method according to the fourth embodiment, four columnar support portions 310 to be removed in a forming course are added to three-dimensional fabrication data of the three-dimensional fabricated object 300 to create fabrication data.

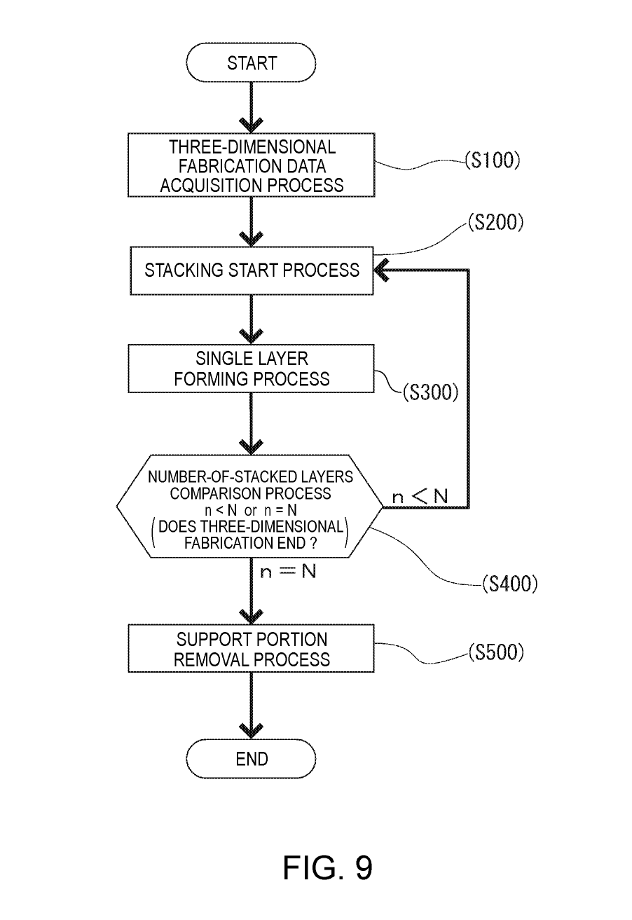

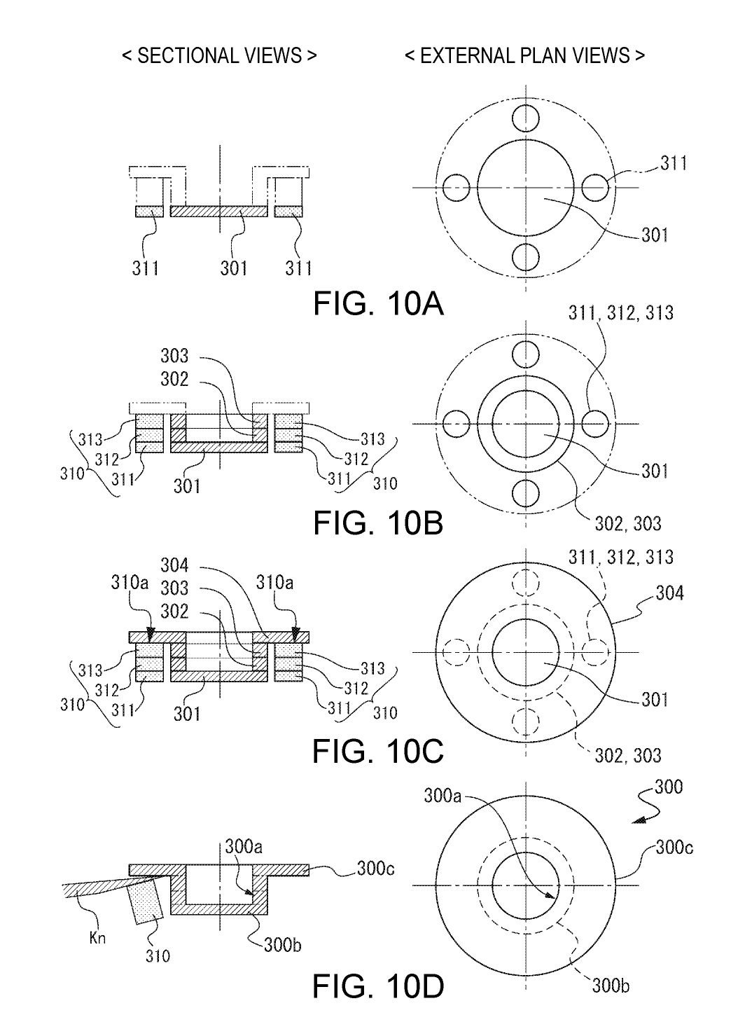

FIG. 9 is a flowchart illustrating a method of forming the three-dimensional fabricated object 300 illustrated in FIGS. 8A and 8B. FIGS. 10A to 10D illustrate a method of forming the three-dimensional fabricated object 300 in the flowchart of FIG. 9, and partial sectional views and external plan views are illustrated on the left side and the right side of the drawings, respectively. In the three-dimensional fabricated object 300 according to the embodiment, an example in which four layers are stacked and formed will be described, but the invention is not limited thereto.

As illustrated in FIG. 10A, first, a partial fabricated object 301 which is a first layer is formed on the sample plate 21 (not illustrated) according to the three-dimensional forming method according to the fourth embodiment. In the process of forming the partial fabricated object 301, partial support portions 311 of the first layer are also formed. The sintering process (S320) of the single layer forming process (S300) described with reference to FIGS. 5A and 5B is not performed on the partial support portions 311, and the single layer forming process (S300) is performed with the fabrication material 80b remaining, that is, unsintered or unmelted.

Subsequently, the single layer forming process (S300) is repeated to form partial fabricated objects 302 and 303 which are second and third layers, as illustrated in FIG. 10B. Then, in a process of forming the partial fabricated objects 302 and 303, partial support portions 312 and 313 of the second and third layers are also formed. As in the partial support portion 311, the sintering process (S320) of the single layer forming process (S300) is not performed on the partial support portions 312 and 313, and the single layer forming process (S300) is performed with the fabrication material 80b remaining, that is, unsintered or unmelted, so that the support portions 310 are formed by the partial support portions 311, 312, and 313.

Next, as illustrated in FIG. 10C, a partial fabricated object 304 of a fourth layer formed in the flange portion 300c is formed. The partial fabricated object 304 is formed to be supported by ends 310a of the support portions 310 formed by the partial support portions 311, 312, and 313. By forming the partial fabricated object 304 in this way, the fabrication material 80b (see FIGS. 7A to 7D) in the paste form formed in the flange portion 300c is supported so that the deformation in the gravity direction is suppressed between the material supply start process (S311) and the laser radiation start process (S321) of the single layer forming process (S300) of forming the partial fabricated object 304.

Then, as illustrated in FIG. 10D, when the three-dimensional fabricated object 300 is fabricated, the support portions 310 are removed from the three-dimensional fabricated object 300 in the support portion removal process (S500). Since the support portions 310 are formed of an unbaked material, the support portions 310 can be physically cut by, for example, a sharp-edged tool Kn which is a removal unit for the support portions 310 in a support portion removal process (S500), as illustrated in FIG. 10D. Alternatively, the three-dimensional fabricated object 300 may be removed by performing immersion in a solvent and dissolving the thickener included in the material.

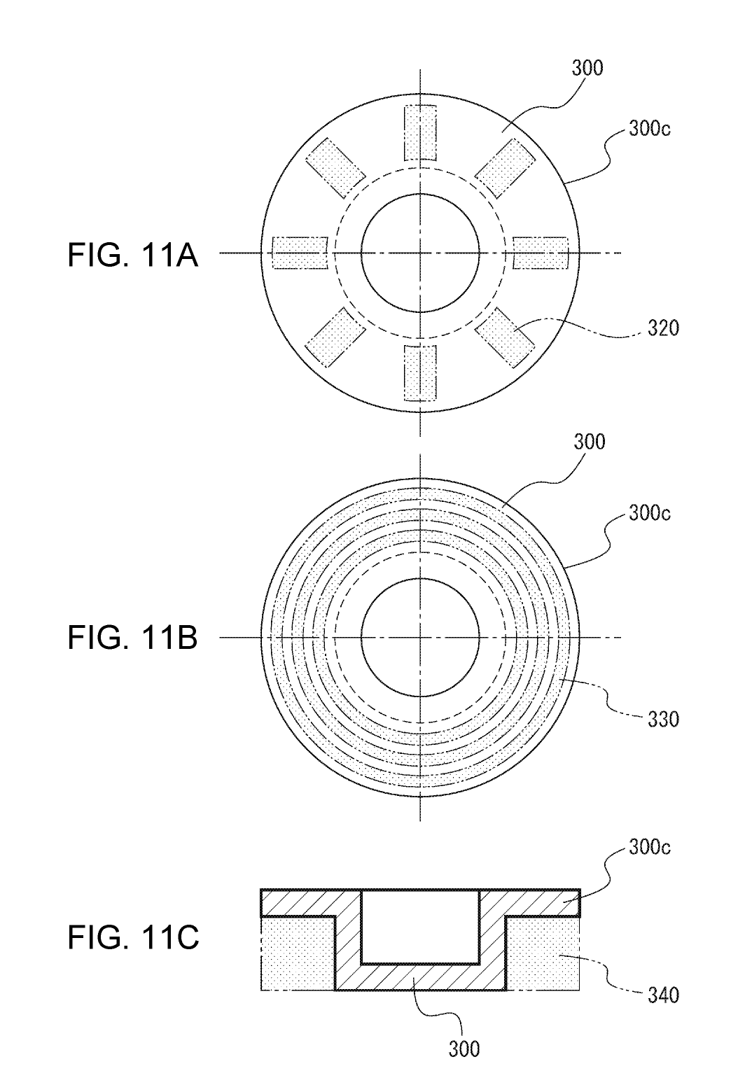

As described above, when the three-dimensional fabricated object 300 including the flange portion 300c which is the overhang is formed, it is possible to prevent the flange portion 300c from being deformed in the gravity direction by forming the support portions 310 supporting the flange portion 300c in conjunction with the forming of the three-dimensional fabricated object 300. The support portions 310 illustrated in FIGS. 8A and 8B are not limited to the plurality of columnar portions, but the shapes, sizes, and the like of the support portions are set according to the shape of the fabricated object, a material composition, or the like. FIGS. 11A to 11C illustrate examples of the other forms of the support portions.

Support portions 320 illustrated in the external plan view of FIG. 11A have a square pillar shape and the support portions 320 are disposed radially. Support portions 330 illustrated in the external plan view of FIG. 11B have a cylindrical shape and the support portions 330 are disposed concentrically. Alternatively, as illustrated in the sectional view of FIG. 11C, a support portion 340 supports all the portions of the flange portion 300c.

The specific configurations in the embodiments of the invention can be appropriately changed to other devices or methods within the scope of the invention in which the object of the invention can be achieved.

What is claimed is:

1. A three-dimensional forming apparatus comprising:
a material supply unit that supplies a stage with a sintering material in which metal powder and a binder are kneaded;
a heating unit that supplies the sintering material supplied from the material supply unit with energy capable of sintering the sintering material; and
a driving unit that is able to move the material supply unit and the heating unit three-dimensionally relative to the stage,
wherein the material supply unit supplies a predetermined amount of the sintering material to a desired position on the stage and the energy is supplied to the supplied sintering material from the heating unit.

2. The three-dimensional forming apparatus according to claim 1, wherein the driving unit includes a control unit that controls a movement path of the heating unit such that the heating unit tracks a movement path of the material supply unit.

3. The three-dimensional forming apparatus according to claim 1,
wherein the three-dimensional forming apparatus includes a plurality of the material supply units, and
wherein at least two kinds of the sintering materials with different compositions are supplied.

4. The three-dimensional forming apparatus according to claim 1, wherein the heating unit is a laser radiation unit.

5. A three-dimensional forming method comprising:
forming a single layer by supplying a sintering material in which metal powder and a binder are kneaded in a desired shape and by supplying energy capable of sintering the sintering material to the sintering material supplied in the supplying of the sintering material and sintering the sintering material; and
stacking a first single layer formed in the forming of the single layer and forming a second single layer in the forming of the single layer,
wherein the stacking of the single layer is repeated a predetermined number of times to form a three-dimensional fabricated object, and
wherein in the forming of the single layer, the sintering of the sintering material starts before end of the supplying of the sintering material, and the supply of the energy is performed tracking the supply of the sintering material so that the sintering material is sintered.

6. The three-dimensional forming method according to claim 5,
wherein in the stacking of the first single layer, a support portion supporting the single layer in a gravity direction is formed, and
wherein the support portion is an unsintered portion to which the energy is not radiated in the sintering of the sintering material.

7. The three-dimensional forming method according to claim 6, further comprising:
removing the support portion.

8. A three-dimensional forming apparatus comprising:
a first arm; and
a second arm,
wherein the first arm includes a material supply nozzle as a material supply unit supplying a stage with a sintering material in which metal powder and a binder are kneaded and the second arm includes a heating device as a heating unit supplying the sintering material supplied from the material supply unit with energy capable of sintering the sintering material,
wherein the three-dimensional forming apparatus further comprises a driving unit that is able to move the first arm and the second arm three-dimensionally relative to the stage, and
wherein the material supply unit supplies a predetermined amount of the sintering material to a desired position on the stage and the energy is supplied to the supplied sintering material from the heating unit.

9. The three-dimensional forming apparatus according to claim 8, wherein the first arm and the second arm include a plurality of joints.

10. A three-dimensional forming apparatus comprising:
a control unit that includes a driving control unit for a first arm including a material supply nozzle and a second arm including a heating device, a driving control unit for a stage to which a sintering material is supplied, an operation control unit for the material supply nozzle included in the first arm, and an operation control unit for the heating device included in the second arm.

11. The three-dimensional forming apparatus according to claim 10, wherein the control unit further includes a controller operating in cooperation with the first arm, the second arm, the stage, the material supply nozzle, and the heating device.
